(19) United States
(12) Patent Application Publication
(10) Pub. No.: US 2023/0015629 A1
(43) Pub. Date: Jan. 19, 2023

(54) PNEUMATIC AUTOMATIC PRESSURE REGULATING VALVE FOR AUTOMATIC DRIVING OF COMMERCIAL VEHICLE AND CONTROL METHOD THEREOF

(71) Applicant: Wuhan University Of Technology, Wuhan (CN)

(72) Inventors: Gangyan LI, Wuhan (CN); Hanwei BAO, Wuhan (CN); Jian HU, Wuhan (CN); Fang YANG, Wuhan (CN)

(73) Assignee: Wuhan University Of Technology, Wuhan (CN)

(21) Appl. No.: 17/726,513

(22) Filed: Apr. 21, 2022

Related U.S. Application Data
(63) Continuation of application No. PCT/CN2021/109033, filed on Jul. 28, 2021.

(30) Foreign Application Priority Data
Jul. 19, 2021 (CN) 202110810990.5

(51) Int. Cl. B60T 15/02; B60T 15/18; B60T 13/68

(52) U.S. Cl. CPC B60T 15/027; B60T 13/683; B60T 15/18

(57) ABSTRACT

A pneumatic automatic pressure regulating valve for automatic driving of a commercial vehicle includes an upper valve body and a lower valve body that form a chamber of the automatic pressure regulating valve. A quick-acting intake valve assembly and a quick-acting exhaust valve assembly are mounted on the upper valve body. A main valve core assembly is mounted on the lower valve body. The quick-acting intake valve and the quick-acting exhaust valve are normally closed and both are configured to regulate an air pressure in the control chamber A such that air enters the working chamber B to increase a pressure or is vented therefrom to reduce the pressure, thereby controlling a pressure in a brake chamber. The pneumatic automatic pressure regulating valve can be widely applied to autonomous vehicles or unmanned driving. The familiarity dependency of a driver on a valve control system is reduced.

### CROSS-REFERENCE TO RELATED APPLICATIONS

This application is a continuation of International Patent Application No. PCT/CN2021/109033 with a filing date of Jul. 28, 2021, designating the United States, now pending, and further claims priority to Chinese Patent Application No. 202110810990.5 with a filing date of Jul. 19, 2021. The content of the aforementioned applications, including any intervening amendments thereto, are incorporated herein by reference.

### TECHNICAL FIELD

The present disclosure relates to the technical field of vehicle braking, and in particular, to an automatic driving-oriented automatic pressure regulating valve for an electro-pneumatic braking system of a commercial vehicle and a control method thereof.

### BACKGROUND ART

With the rapid development of the automatic driving technology and the unmanned driving technology, automatic driving can be implemented in an increasing number of vehicles. As the core part for guaranteeing safe driving of a vehicle, a braking system is gradually developing toward an automatic and intelligent electro-pneumatic braking system to meet the requirements of automatic driving and unmanned driving. A traditional pneumatic braking system operates with a driver as the control core of braking and may response at a speed depending on whether a driver responds quickly. Meanwhile, due to the inherent characteristics of the system, the traditional pneumatic braking system has the problems of long response time delay and failure to regulate a braking pressure accurately in real time, and thus cannot meet the requirements of automatic driving. An electro-pneumatic braking system is a novel braking system applicable to an autonomous vehicle, which can give a target braking pressure according to the driving condition of the vehicle and regulate in real time the pressure of a brake chamber to be consistent with the target pressure, thereby completing intelligent braking by itself. Such a braking system can realize stable and comfortable braking while guaranteeing the braking safety of the vehicle.

The traditional pneumatic braking system is controlled by a driver and may operate to implement braking by means of pressure regulating valves such as a pedal valve, an anti-lock braking system (ABS) valve and a relay valve. These valves are all pneumatically controlled valves, which cannot meet the requirements of the electro-pneumatic braking systems on, for example, braking safety, stability and ride comfort, and thus cannot be applied to an autonomous vehicle. At present, there are few studies on the automatic driving technology for a commercial vehicle because the commercial vehicle is usually large in size and has the disadvantages of complicated braking system and difficult braking process. Besides, there are also few studies on an automatic driving-oriented automatic pressure regulating valve for an electro-pneumatic braking system of a commercial vehicle.

### SUMMARY

To address the technical problems and the above-mentioned defects in the prior art, the present disclosure provides a pneumatic automatic pressure regulating valve for automatic driving of a commercial vehicle and a control method thereof that can be widely applied to autonomous vehicles or unmanned driving and can receive signals from an electro-pneumatic braking system, reduce the familiarity dependency of a driver on a valve control system, realize rapid and accurate regulation of the pressure of a brake chamber such that the regulated pressure is consistent with a target pressure determined by the electro-pneumatic braking system after analyzing a driving condition, and thus guarantee the safety, stability and ride comfort during braking. Moreover, fewer electromagnetic valves are used and the electromagnetic valve structure is improved. The upper valve body is simple. The overall manufacturing cost is low.

To solve the above technical problems, the present disclosure adopts the following technical solutions.

A pneumatic automatic pressure regulating valve for automatic driving of a commercial vehicle includes an upper valve body and a lower valve body that form a chamber of the automatic pressure regulating valve. The chamber of the automatic pressure regulating valve chamber is divided by a piston into an upper control chamber A and a lower working chamber B. A quick-acting intake valve assembly and a quick-acting exhaust valve assembly are mounted on the upper valve body. A main valve core assembly is mounted on the lower valve body. The quick-acting intake valve and the quick-acting exhaust valve are normally closed and both are configured to act correspondingly after receiving signals from a controller to regulate an air pressure in the control chamber A such that air enters the working chamber B to increase a pressure or is vented therefrom to reduce the pressure, thereby controlling a pressure in a brake chamber.

According to the above technical solution, the acting correspondingly may include filling the control chamber A with air by allowing an air storage tank to be communicated with the control chamber A, or venting air from the control chamber A by allowing the control chamber A to be communicated with the atmosphere.

According to the above technical solution, the quick-acting intake valve and the quick-acting exhaust valve may be both normally closed two-position two-way electromagnetic valves that are configured to be de-energized and closed when vehicle braking is not performed. The quick-acting intake valve and the quick-acting exhaust valve are both connected to the controller and controlled by the controller to act. A flow passage is formed in iron cores of the quick-acting intake valve and the quick-acting exhaust valve. A groove is formed around the flow passage. The flow passage is connected to an air inlet and an air outlet formed in the upper valve body by means of the groove, thereby allowing air to circulate upper valve body. An electromagnetic coil is embedded into each iron core. A movable iron core is located in an upper valve body end cover. A wiring hole for the electromagnetic coil is formed in the upper valve body end cover.

According to the above technical solution, the quick-acting intake valve has an air inlet a connected to the air storage tank and an air outlet b connected to the control chamber A of the lower valve body. When vehicle braking is performed, the quick-acting intake valve acts such that the air storage tank is communicated with the control chamber A of the lower valve body, allowing air in the air storage tank to enter the control chamber A of the lower valve body. The quick-acting exhaust valve has an air inlet c connected to the control chamber A of the lower valve body and an air outlet communicated with the atmosphere. When vehicle braking is released, the quick-acting exhaust valve acts to vent air in the control chamber A to the atmosphere. A muffler is disposed at the air outlet. The controller controls the quick-acting intake valve and the quick-acting exhaust valve to act repeatedly to regulate the pressure in the control chamber, thereby controlling a braking pressure.

According to the above technical solution, a guide piece is disposed above the piston to work in coordination with a limiting hole formed in the upper valve body, guaranteeing the motion of the piston in a vertical direction. A protrusion is formed on a lower portion of the piston to form a linear seal with the main valve core assembly, guaranteeing leakproofness. The main valve core assembly is located in the lower valve body. The lower valve body has a limiting guide piece, guaranteeing the motion of the main valve core assembly in the vertical direction. The motion of the main valve core is controlled by the piston and a return spring of the main valve core assembly. A sealing ring is disposed at a position where the main valve core assembly is in contact with the piston to guarantee leakproofness. The main valve core and the piston form a separable mechanism. The main valve core has a hollow structure and serves as an exhaust port to vent air.

According to the above technical solution, a pressure detection hole h is formed below the air outlet of the automatic pressure regulating valve and connected to a pressure sensor to detect in real time an air pressure at the air outlet. A signal from the pressure sensor is fed back to the controller, thereby completing closed-loop regulation of the pressure of the brake chamber and finally realizing real-time regulation of the braking pressure.

A control method of a pneumatic automatic pressure regulating valve for automatic driving of a commercial vehicle includes the following steps:
(1) detecting, by an electro-pneumatic braking system of the commercial vehicle, a driving condition of the vehicle, generating a target braking pressure P₁ for a vehicle brake chamber at this time according to the driving condition of the vehicle, and inputting the target pressure P₁ to a controller;
(2) detecting, by a pressure sensor, a pressure P₂ at an air outlet of the automatic pressure regulating valve, and inputting the pressure P₂ at the air outlet to the controller;
(3) comparing, by the controller, the target braking pressure P₁ with the pressure P₂ at the air outlet of the automatic pressure regulating valve, and obtaining driving signals for a quick-acting intake valve and a quick-acting exhaust valve by using a corresponding control algorithm based on a comparison result;
(4) when P₂ is not higher than P₁, controlling, by the controller, the quick-acting intake valve to be energized to be opened and the quick-acting exhaust valve to be de-energized to be closed such that an air storage tank is communicated with a control chamber A while the control chamber A is disconnected from the atmosphere, causing a pressure in the control chamber A to rise to push down a main valve core, thereby increasing the opening of the valve and increasing the pressure P₂ at the air outlet;
(5) when P₂ is higher than P₁, controlling, by the controller, the quick-acting intake valve to be de-energized to be closed and the quick-acting exhaust valve to be energized to be opened such that the air storage tank is disconnected from the control chamber A while the control chamber A is communicated with the atmosphere, causing the pressure in the control chamber A to drop, thereby reducing the opening of the valve; causing a piston to continuously move up if the pressure in the control chamber A continuously drops after the valve is fully closed, and separating the piston from the main valve core such that the air outlet is communicated with an exhaust port to vent air in the brake chamber to the atmosphere, causing the P₂ at the air outlet to drop; and
(6) controlling, by the controller, the quick-acting intake valve and the quick-acting exhaust valve to work cooperatively to regulate the outlet pressure P₂ of the automatic pressure regulating valve such that the outlet pressure reaches the desired target pressure P₁ rapidly and accurately, thereby realizing efficient and safe braking.

Thus, the present disclosure discloses a novel automatic driving-oriented automatic pressure regulating valve for an electro-pneumatic braking system of a commercial vehicle and a control method thereof. The automatic pressure regulating valve includes an upper valve body and a valve body. The upper valve body mainly includes a quick-acting intake valve and a quick-acting exhaust valve, and the main structure of the lower valve body is a relay valve. The quick-acting intake valve has an air inlet a connected to an air storage tank, an air outlet b connected to a control port of a control chamber A of the lower valve body. The quick-acting exhaust valve has an air inlet c connected to the control port of the control chamber of the lower valve body and an air outlet d communicated with the atmosphere. The main structure of the lower valve body is a relay valve which has a chamber divided by a piston into two independent chambers, namely a control chamber A and a working chamber B. The control chamber A has a control port. The working chamber B has an air inlet e connected to a vehicle braking air storage tank, an air outlet f connected to a vehicle brake chamber, and an exhaust port g communicated with the atmosphere. Valves are disposed between the air inlet and the air outlet and between the air outlet and the exhaust port to implement on-off control. In the working process, the quick-acting intake valve and the quick-acting exhaust valve receive control signals from a controller. The magnitude of the pressure in the control chamber A is regulated to control the piston to move up and down such that the air inlet is communicated with the air outlet or the air outlet is communicated with the exhaust port, thereby controlling the pressures at the air outlet of the valve and in the vehicle brake chamber. A pressure sensor is disposed at the air outlet to detect the air pressure in real time and feeds back a pressure signal to the controller, thereby realizing closed-loop regulation of the pressure in the brake chamber. The automatic pressure regulating valve is applied to an autonomous vehicle, and is highly automated to allow for accurate, efficient and rapid braking of the autonomous vehicle, guaranteeing the safety and ride comfort during vehicle braking.

Compared with the prior art, the present disclosure has the following beneficial effects:
(1) The present disclosure is oriented to automatic driving and applied to an electro-pneumatic braking system of a commercial vehicle, and can increase the automation level of the vehicle braking system. The electro-pneumatic braking system detects and analyzes a road condition first and then controls the automatic pressure regulating valve to implement braking. The automatic pressure regulating valve is the basis for realizing automatic driving and unmanned driving of the vehicle.
(2) The present disclosure employs a quick-acting electromagnetic valve as a control component to implement on-off control of the pneumatic loop. The length of the pneumatic piping can be significantly reduced, and the air transmission time delay of the pneumatic braking system can be shortened.
(3) The present disclosure employs a pressure detecting device disposed at the air outlet of the automatic pressure regulating valve to detect a vehicle braking pressure in real time and feed back a braking pressure signal to a controller such that the controller can regulate the braking pressure in real time according to the feedback signal.

### BRIEF DESCRIPTION OF THE DRAWINGS

FIG. 1 is a schematic diagram of a pneumatic automatic pressure regulating valve for automatic driving of a commercial vehicle according to the present disclosure.

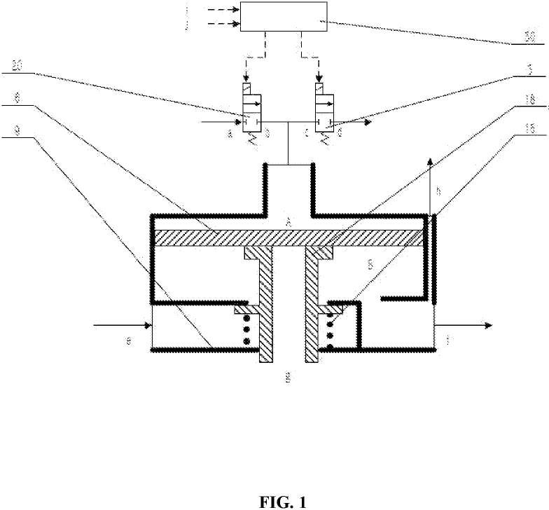

FIG. 2 is an overall external view of a pneumatic automatic pressure regulating valve for automatic driving of a commercial vehicle according to the present disclosure.

FIG. 3 is a top view of a pneumatic automatic pressure regulating valve for automatic driving of a commercial vehicle and a control method thereof according to the present disclosure.

FIG. 4 is a right view according to the present disclosure.

FIG. 5 is a sectional view taken along line A-A in FIG. 3.

FIG. 6 is a partial enlarged view of structure I in FIG. 5.

List of Reference Numerals: 1-upper valve body end cover, 2-upper valve body part, 3-quick-acting exhaust valve, 4-muffler, 5-plug, 6-piston, 7-piston sealing ring, 8-valve body sealing ring, 9-lower valve body part, 10-spring seat, 11-spring seat sealing ring, 12-stop collar, 13-rubber muffler, 14-lower main valve core sealing ring, 15-main valve core return spring, 16-upper collar of main valve core return spring, 17-middle main valve core sealing ring, 18-main valve core, 19-upper main valve core sealing ring, 20-quick-acting intake valve, 21-upper valve body end cover sealing ring, 22-coil, 23-static iron core, 24-lower quick-acting electromagnetic valve core sealing ring, 25-quick-acting electromagnetic valve core return spring, 26-quick-acting electromagnetic valve core, 27-quick-acting electromagnetic valve sealing ring, 28-upper quick-acting electromagnetic valve core sealing ring, 29-armature, 30-controller, a-air inlet of quick-acting intake valve, b-exhaust port of quick-acting intake valve, c-air inlet of quick-acting exhaust valve, d-air outlet of quick-acting exhaust valve, e-air inlet of automatic pressure regulating valve, f-air outlet of automatic pressure regulating valve, g-exhaust port of automatic pressure regulating valve, h-pressure detection hole, i-controller power interface, j-controller signal interface, A-control chamber, and B-working chamber.

### DETAILED DESCRIPTION OF THE EMBODIMENTS

The present disclosure will be described in detail below in conjunction with the accompanying drawings and embodiments.

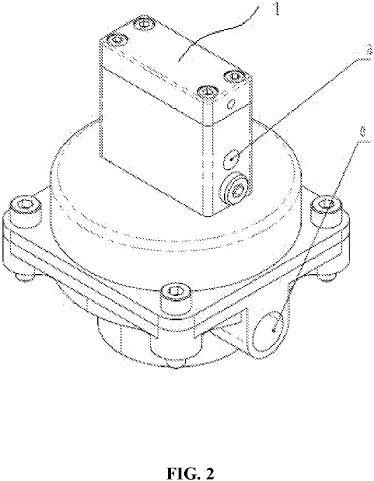

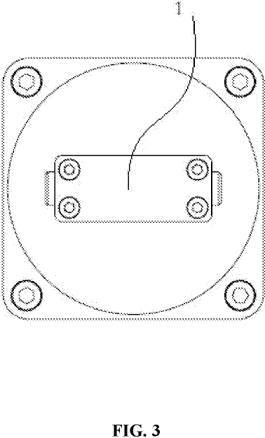

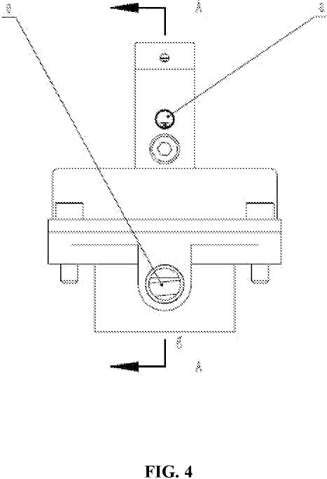

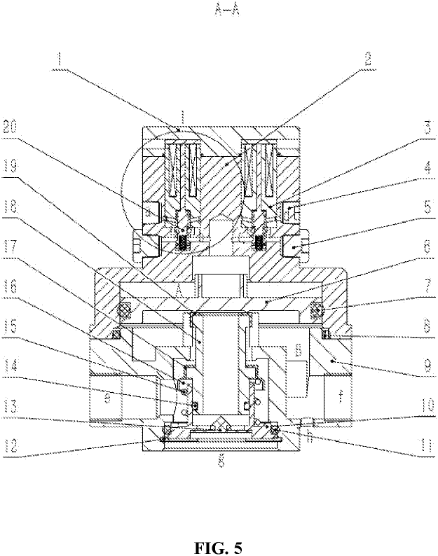

As shown in FIG. 2 to FIG. 6, the present disclosure is an automatic driving-oriented automatic pressure regulating valve for an electro-pneumatic braking system of a commercial vehicle, which is composed of an upper valve body and a lower valve body. The main portion of the main upper valve body is an upper valve body housing part 2. A quick-acting intake valve 20 and a quick-acting exhaust valve 3 are positioned and mounted through mounting holes formed in an upper valve body part. An air inlet a and an air outlet b of the quick-acting intake valve and an air inlet c and an air outlet d of the quick-acting exhaust valve are formed in the upper valve body. The air inlet a of the quick-acting intake valve is connected to an air storage tank, while the air outlet is connected to a control chamber A. The air inlet c of the quick-acting exhaust valve is connected to the control chamber A, while the air outlet d is communicated with the atmosphere. A muffler 4 is mounted at the air outlet d of the quick-acting exhaust valve. An air inlet and an air outlet formed in the upper valve body part are communicated with the quick-acting intake valve 20 and the quick-acting exhaust valve 3 to implement on-off control of a pneumatic loop.

An end cover 1 is disposed above the upper valve body part and fixed to the upper valve body by means of a bolt. Connection holes for electronic control harnesses of the quick-acting intake valve and the quick-acting exhaust valve are formed on two sides of the end cover. A sealing ring 21 is disposed between the upper valve body part and the upper valve body end cover.

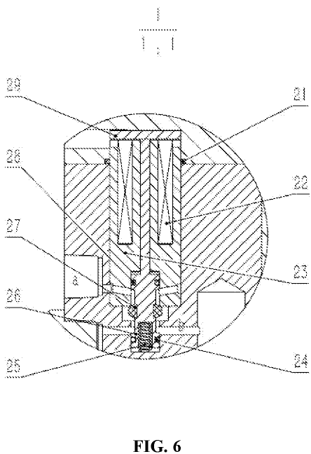

The automatic pressure regulating valve employs the quick-acting intake valve 20 and the quick-acting exhaust valve 3 to control the pressure of the control chamber A, thereby controlling a vehicle braking pressure. The quick-acting intake valve and the quick-acting exhaust valve are mounted in the upper valve body 2 and communicated with or disconnected from the air inlet and the air outlet formed in the upper valve body part to implement on-off control of the pneumatic loop. The quick-acting intake valve 20 and the quick-acting exhaust valve 3 have a same structure. FIG. 6 shows a partially enlarged view of the quick-acting intake valve 20. The quick-acting intake valve 20 is provided with an integrated static iron core 23. A mounting hole and a wiring hole for an electromagnetic coil 22 are formed in the static iron core 23, and the electromagnetic coil 22 is mounted therein. The static iron core 23 is provided with an air flow passage. A groove is formed around the air flow passage and connected to the air inlet a in the upper valve body to reduce the resistance to air transmission while facilitating positioning and mounting. A mounting hole for a quick-acting intake valve core 26 is formed in the center of the static iron core 23 for positioning and mounting of a main valve core. The lower portion of the static iron core 23 acts together with a quick-acting electromagnetic valve sealing ring 27 located on the main valve core to realize the function of the valve. The valve sealing ring 27 moves up and down to implement on-off control of the pneumatic loop. An end cover sealing ring 21 is disposed between the upper valve body part 2 and the upper valve body end cover 1. An armature 29 is disposed in the upper valve body end cover and located above the static iron core 23. The armature 29 is ring-shaped and has a same diameter with the static iron core 23 such that a great electromagnetic force can be produced to realize effective attraction after an electromagnet is energized, thereby pushing the quick-acting intake valve core 26 to move down. The quick-acting intake valve core 26 is located within the static iron core 23 and has on an upper portion thereof a long rod-like structure that extends through the entire static iron core 23 and is in contact with the armature 29, allowing the armature 29 to control the motion of the main valve core 26. Meanwhile, the rod-like structure may play a role in limiting and guiding to guarantee that the quick-acting intake valve core 26 to move in the vertical direction. An upper valve core sealing ring 28 is disposed at a position where the quick-acting intake valve core 26 is in contact with the static iron core 23, and a sealing ring 24 is disposed at a position where the quick-acting intake valve core 26 is in contact with the upper valve body part, thereby guaranteeing that air in a pneumatic piping does not leak to cause pressure relief. A return spring 25 is disposed below the quick-acting intake valve, and a valve sealing ring 27 is located between the static iron core and the upper valve body part 2. The main valve core 26 moves up and down under the combined action of the armature and the return spring to implement on-off control of the pneumatic piping.

The quick-acting intake valve 20 and the quick-acting exhaust valve 3 follow the same working principle, which will be explained below by taking the quick-acting intake valve for example. When the quick-acting intake valve is de-energized, no current flows through the electromagnetic coil 22, and no electromagnetic force is produced by the electromagnet. Under the action of the return spring 25, the quick-acting intake valve core 26 pushes the armature 29 to move upwards, and the valve core is located at an initial position. At this time, the valve sealing ring 27 of the quick-acting intake valve is held down on the static iron core 23 under the action of the return spring 25 such that the valve is closed and the air course is blocked. When the quick-acting intake valve is energized, the electromagnetic coil 22 is energized to produce an electromagnetic force to attract the armature 29. When the attractive force of the electromagnetic coil 22 for the armature 29 is greater than the force of the return spring 25, the armature 29 is attracted to move down and simultaneously pushes the quick-acting intake valve core 26 to move down. At this time, the valve sealing ring 27 of the quick-acting intake valve is separated from the static iron core 23 such that the valve is opened and the air course is enabled. The air inlet a and the air outlet b of the quick-acting intake valve are communicated with each other such that air from an air storage tank enters the control chamber A, causing the air pressure in the control chamber A to rise.

The upper valve body part 20 is connected to the lower valve body part 9 by means of a bolt, and a valve body sealing ring 8 is disposed therebetween. The chamber of the upper valve body and the chamber of the lower valve body form the chamber of the automatic pressure regulating valve. Moreover, the chamber of the automatic pressure regulating valve is divided by a piston 6 into the control chamber A which is located between the upper valve body part 20 and the piston 6 and a working chamber B which is located between the piston 6 and the lower valve body part. A motion guiding hole for the piston 6 is formed in the upper valve body part 20 and a guide piece is disposed above the piston 6, and the motion of the piston in the vertical direction can be guaranteed under the combined action of the motion guiding hole and the guide piece. A piston sealing ring 7 is disposed around the piston 6. The piston 6 may be separated from a main valve core assembly such that the exhaust port of the automatic pressure regulating valve is opened. A protrusion is formed on a lower portion of the piston 6, which can form a linear seal with the main valve core assembly to guarantee the leakproofness.

The lower valve body is composed of the lower valve body part 9 and a main valve core part. The lower valve body part 9 has an air inlet e, an air outlet f, an exhaust port g, and a pressure detection hole g, and the lower valve body further includes the working chamber B. A main valve core guide structure is disposed above the lower valve body part 9 to guide the motion of the main valve core 18 in the vertical direction. The guide piece may also serve as a member for limiting a displacement to limit the travel of the piston 6 in the vertical direction. The main valve core assembly is composed of components such as a main valve core 18 and a main valve core return spring 15. An upper sealing ring 19 is disposed at the top end of the main valve core 18 to guarantee the leakproofness together with the protrusion on the piston 6. A middle sealing ring 17 is disposed in the middle of the main valve core 18 to control opening of the valve; a main valve core return spring 16 is disposed below the sealing ring 17 to fix the main valve core return spring 15 together with the spring seat 10. A stop collar 12 is disposed below the spring seat 10 to fix and adjust the position of the spring seat 10. A lower main valve core sealing ring 14 is disposed between the main valve core 18 and the spring seat 10. A spring seat sealing ring 11 is disposed between the spring seat 10 and the lower valve body part 9. A rubber muffler 13 is disposed below the main valve core.

The air inlet a of the quick-acting intake valve 20 of the automatic pressure regulating valve is connected to the air storage tank of the braking system, while the air outlet is connected to the control chamber A of the automatic pressure regulating valve. The air inlet c of the quick-acting exhaust valve 3 is connected to the control chamber A of the automatic pressure regulating valve, while the air outlet d is communicated with the atmosphere. The air inlet e of the automatic pressure regulating valve is connected to the air storage tank, while the air outlet f is connected to a vehicle brake chamber and the exhaust port g is communicated with the atmosphere. The working chamber B is located below the piston. When vehicle braking is desired, the controller 30 controls the quick-acting intake valve 20 to be energized such that the electromagnet attracts the armature 29 to move down against the force of the return spring 25, thereby pushing the quick-acting intake valve core 26 to move down to open the valve. The air inlet a is communicated with the air outlet b, allowing compressed air to enter the control chamber A. When the air pressure in the control chamber A that acts on the piston 6 is greater than the force of the main valve core return spring 15, the piston 6 moves down under the action of the compressed air to push the main valve core 18 to move down. The protrusion on the lower portion of the piston 6 is in contact with the upper sealing ring 19 at the top end of the main valve core to guarantee that the compressed air does not be vented through the exhaust port g to the atmosphere. The main valve core moves down, causing the middle main valve core sealing ring 17 to separate from the lower valve body part 9 such that the main valve is opened. Compressed air in the air storage tank then enters the vehicle brake chamber via the air inlet e, the main valve, the working chamber B, and the air outlet f Moreover, with gradually increasing downward movement travel of the main valve core, the opening of the main valve gradually increases as well and the air pressure in the vehicle brake chamber also rises to brake the vehicle.

When the vehicle needs to be released from braking, the controller 30 controls the quick-acting intake valve 20 to be de-energized. At this time, the attraction of the electromagnet of the quick-acting intake valve to the armature 29 disappears. Under the action of the quick-acting intake valve return spring 25, the quick-acting intake valve core 26 moves upwards, and the quick-acting intake valve 27 moves upwards to come into contact with the static iron core 23 such that the valve is closed. The quick-acting intake valve is closed to break the connection between the air storage tank and the control chamber A, thereby preventing compressed air from entering the control chamber. Meanwhile, the controller controls the quick-acting exhaust valve 3 to be energized to act in the same way with the quick-acting intake valve 20 when energized, thereby connecting the control chamber A with the atmosphere. Thus, the compressed air in the control chamber A is vented to the atmosphere, leading to reduced pressure of the compressed air. Under the combined action of the main valve core return spring 15 and the compressed air in the control chamber A, the main valve core moves upwards, resulting in reduced opening of the main valve and less compressed air entering the vehicle brake chamber. When the middle main valve core sealing ring 17 is in contact with the lower valve body part, the main valve is fully closed. As the pressure of the compressed air in the control chamber A drops continuously, the piston 6 continues to move upwards to separate from the main valve core 18. At this time, the air outlet f and the exhaust port g of the automatic pressure regulating valve are communicated with each other such that the compressed air in the brake chamber is vented to the atmosphere through the air outlet f, the working chamber B, and the exhaust port g. Thus, pressure relief of the brake chamber is completed, and vehicle braking is released.

An embodiment of the automatic driving-oriented automatic pressure regulating valve for an electro-pneumatic braking system of a commercial vehicle is described below.

The automatic pressure regulating valve is applied to an autonomous vehicle and serves as the key component of an electro-pneumatic braking system to assist the entire system with autonomous braking of the autonomous vehicle, To meet the requirements of independent and quick pressure regulation, the automatic pressure regulating valve is mounted in front of each wheel brake chamber of the vehicle to independently regulate the braking pressure of each wheel brake chamber. In the driving process of the vehicle, the electro-pneumatic braking system of the vehicle will calculate a target braking pressure P₁ for each wheel brake chamber based on the driving condition of the vehicle in combination with a vehicle dynamic model and inputs the target braking pressure P₁ of each wheel brake chamber to a corresponding controller. At this time, a pressure sensor mounted at the pressure detection hole h of the automatic pressure regulating valve detects the braking pressure P₂ at the air outlet f and feeds back the braking pressure P₂ to the controller. The controller compares the air outlet braking pressure P₂ with the target braking pressure P₁. Meanwhile, the controller runs a control algorithm embedded therein to generate control signals for the quick-acting intake valve and the quick-acting exhaust valve. When the air outlet braking pressure P₂ is not higher than the target braking pressure P₁, the controller controls the quick-acting intake valve to be energized. The electromagnetic coil of the quick-acting intake valve then is energized to generate an electromagnetic force. When the electromagnetic force is greater than the force of the quick-acting electromagnetic valve return spring, the armature is attracted to move down while driving the quick-acting intake valve core to move down such that the air inlet a and the air outlet b of the quick-acting intake valve are communicated with each other. At this time, the quick-acting exhaust valve is de-energized and closed. The compressed air in the air storage tank enters the control chamber A, causing the air pressure in the control chamber A to increase. When the pressure acting on the upper surface of the piston is higher than the force of the main valve core return spring, the main valve core is pushed by the piston to move down. The valve sealing ring of the main valve core is separated from the lower valve body part such that the main valve of the automatic pressure regulating valve is opened and the air inlet e is communicated with the air outlet f through the main valve, allowing the compressed air in the air storage tank to enter the brake chamber and causing the air outlet braking pressure P₂ to increase. When the controller detects that the air outlet braking pressure P₂ is higher than the target braking pressure P₁, the controller controls the quick-acting intake valve to be de-energized to be closed, stopping the compressed air in the air storage tank from entering the control chamber A. Meanwhile, the controller controls the quick-acting exhaust valve to be energized such that the coil of the quick-acting exhaust valve produces an electromagnetic force. When the electromagnetic force is greater than the force of the quick-acting exhaust valve return spring, the electromagnet attracts the armature to drive the main valve core of the quick-acting exhaust valve to move down such that the valve is opened. At this time, the air inlet c and the air outlet d of the quick-acting exhaust valve are communicated with each other and the control chamber A is communicated with the atmosphere such that the compressed air in the control chamber A is vented to the atmosphere, resulting in a pressure drop. When the force of the main valve body return spring is greater than the air pressure acting on the upper surface of the piston, the piston moves upwards to drive the main valve core to move up such that the valve sealing ring of the main valve core comes into contact with the lower valve body part to close the valve. The air pressure in the control chamber A continues to drop and the piston continues to move up. Since the main valve core is limited by the lower valve body part from continuously moving up, the piston is separated from the main valve core. At this time, the air outlet is communicated with the exhaust port such that the compressed air in the brake chamber is vented to the atmosphere, causing the air outlet braking pressure P₂ to drop.

The controller of the automatic pressure regulating valve has a control algorithm which can be used to provide control signals for the quick-acting intake valve and the quick-acting exhaust valve after comparing the air outlet braking pressure P₂ with the target braking pressure P₁. The quick-acting intake valve and the quick-acting exhaust valve may then be controlled to act repeatedly to regulate the pressure of the control chamber A, finally achieving the purpose of guaranteeing that the air outlet braking pressure P₂ is consistent with the target braking pressure P₁.

The present disclosure is not limited to the foregoing embodiments. On the basis of the technical solutions disclosed in the present disclosure, a person skilled in the art can make some replacements and variations to some of the technical features according to the disclosed technical contents without creative effort, and such replacements and variations shall all fall within the protection scope of the present disclosure.

What is claimed is:

1. A pneumatic automatic pressure regulating valve for automatic driving of a commercial vehicle, comprising an upper valve body and a lower valve body that form a chamber of the automatic pressure regulating valve, wherein the chamber of the automatic pressure regulating valve chamber is divided by a piston into an upper control chamber A and a lower working chamber B; a quick-acting intake valve assembly and a quick-acting exhaust valve assembly are mounted on the upper valve body; a main valve core assembly is mounted on the lower valve body; and the quick-acting intake valve and the quick-acting exhaust valve are normally closed and both are configured to act correspondingly after receiving signals from a controller to regulate an air pressure in the control chamber A such that air enters the working chamber B to increase a pressure or is vented therefrom to reduce the pressure, thereby controlling a pressure in a brake chamber.

2. The pneumatic automatic pressure regulating valve according to claim 1, wherein the acting correspondingly comprises filling the control chamber A with air by allowing an air storage tank to be communicated with the control chamber A, or venting air from the control chamber A by allowing the control chamber A to be communicated with the atmosphere.

3. The pneumatic automatic pressure regulating valve according to claim 1, wherein the quick-acting intake valve and the quick-acting exhaust valve are both normally closed two-position two-way electromagnetic valves that are configured to be de-energized and closed when vehicle braking is not performed; the quick-acting intake valve and the quick-acting exhaust valve are both connected to the controller and controlled by the controller to act; a flow passage is formed in iron cores of the quick-acting intake valve and the quick-acting exhaust valve; a groove is formed around the flow passage; the flow passage is connected to an air inlet and an air outlet formed in the upper valve body by means of the groove, thereby allowing air to circulate upper valve body; an electromagnetic coil is embedded into each iron core; a movable iron core is located in an upper valve body end cover; and a wiring hole for the electromagnetic coil is formed in the upper valve body end cover.

4. The pneumatic automatic pressure regulating valve according to claim 1, wherein the quick-acting intake valve has an air inlet a connected to the air storage tank and an air outlet b connected to the control chamber A of the lower valve body; when vehicle braking is performed, the quick-acting intake valve acts such that the air storage tank is communicated with the control chamber A of the lower valve body, allowing air in the air storage tank to enter the control chamber A of the lower valve body; the quick-acting exhaust valve has an air inlet c connected to the control chamber A of the lower valve body and an air outlet communicated with the atmosphere; when vehicle braking is released, the quick-acting exhaust valve acts to vent air in the control chamber A to the atmosphere; a muffler is disposed at the air outlet; and the controller controls the quick-acting intake valve and the quick-acting exhaust valve to act repeatedly to regulate the pressure in the control chamber, thereby controlling a braking pressure.

5. The pneumatic automatic pressure regulating valve according to claim 1, wherein a guide piece is disposed above the piston to work in coordination with a limiting hole formed in the upper valve body, guaranteeing the motion of the piston in a vertical direction; a protrusion is formed on a lower portion of the piston to form a linear seal with the main valve core assembly, guaranteeing leakproofness; the main valve core assembly is located in the lower valve body; the lower valve body has a limiting guide piece, guaranteeing the motion of the main valve core assembly in the vertical direction; the motion of the main valve core is controlled by the piston and a return spring of the main valve core assembly; a sealing ring is disposed at a position where the main valve core assembly is in contact with the piston to guarantee leakproofness; the main valve core and the piston form a separable mechanism; and the main valve core has a hollow structure and serves as an exhaust port to vent air.

6. The pneumatic automatic pressure regulating valve according to claim 1, wherein a pressure detection hole h is formed below the air outlet of the automatic pressure regulating valve and connected to a pressure sensor to detect in real time an air pressure at the air outlet; a signal from the pressure sensor is fed back to the controller, thereby completing closed-loop regulation of the pressure of the brake chamber and finally realizing real-time regulation of the braking pressure.

7. A method for controlling a pneumatic automatic pressure regulating valve for automatic driving of a commercial vehicle, comprising the following steps:
(1) detecting, by an electro-pneumatic braking system of the commercial vehicle, a driving condition of the vehicle, generating a target braking pressure P₁, for a vehicle brake chamber at this time according to the driving condition of the vehicle, and inputting the target pressure P₁, to a controller;
(2) detecting, by a pressure sensor, a pressure P₂ at an air outlet of the automatic pressure regulating valve, and inputting the pressure P₂ at the air outlet to the controller;
(3) comparing, by the controller, the target braking pressure P₁, with the pressure P₂ at the air outlet of the automatic pressure regulating valve, and obtaining driving signals for a quick-acting intake valve and a quick-acting exhaust valve by using a corresponding control algorithm based on a comparison result;
(4) when P₂ is not higher than P₁ ,, controlling, by the controller, the quick-acting intake valve to be energized to be opened and the quick-acting exhaust valve to be de-energized to be closed such that an air storage tank is communicated with a control chamber A while the control chamber A is disconnected from the atmosphere, causing a pressure in the control chamber A to rise to push down a main valve core, thereby increasing the opening of the valve and increasing the pressure P₂ at the air outlet;
(5) when P₂ is higher than P₁, controlling, by the controller, the quick-acting intake valve to be de-energized to be closed and the quick-acting exhaust valve to be energized to be opened such that the air storage tank is disconnected from the control chamber A while the control chamber A is communicated with the atmosphere, causing the pressure in the control chamber A to drop, thereby reducing the opening of the valve; causing a piston to continuously move up if the pressure in the control chamber A continuously drops after the valve is fully closed, and separating the piston from the main valve core such that the air outlet is communicated with an exhaust port to vent air in the brake chamber to the atmosphere, causing the P₂ at the air outlet to drop; and
(6) controlling, by the controller, the quick-acting intake valve and the quick-acting exhaust valve to work cooperatively to regulate the outlet pressure P₂ of the automatic pressure regulating valve such that the outlet pressure reaches the desired target pressure P₁, rapidly and accurately, thereby realizing efficient and safe braking.
